(19) United States
(12) Patent Application Publication
(10) Pub. No.: US 2026/0141360 A1
(43) Pub. Date: May 21, 2026

(54) COMPUTER-IMPLEMENTED METHODS, SYSTEMS COMPRISING COMPUTER-READABLE MEDIA, AND ELECTRONIC DEVICES FOR GROUP PAYMENT ROUTING IN OPEN BANKING

(71) Applicant: Mastercard International Incorporated, Purchase, NY (US)

(72) Inventors: David Vorhies, Saint Charles, MO (US); Christopher T. Scholl, Manchester, MO (US); Shawn Mehrhoff, Sappington, MO (US)

(73) Assignee: Mastercard International Incorporated, Purchase, NY (US)

(21) Appl. No.: 18/954,593

(22) Filed: Nov. 21, 2024

(51) Int. Cl. G06Q 20/06; G06Q 20/38; G06Q 20/40

(52) U.S. Cl. CPC G06Q 20/06; G06Q 20/382; G06Q 20/40

(57) ABSTRACT

A computer-implemented method for routing a group payment based upon OB data includes: receiving, via a financial technology service provider device from an organizer device, terms of an automated payment agreement. The terms may include an execution date of the group payment, an amount apportioned to each participant of the group payment, and contact information of each participant of the group payment. The method may further include generating, via the financial technology service provider device, an automated payment agreement having the terms; transmitting the terms of the automated payment agreement to each participant device using the contact information of each participant of the group payment; receiving, from an OB service provider device, a proposed alternative date on which to withdraw the amount based on the OB data; and transmitting to a selected financial institution device a request to draw funds on the proposed alternative date.

### FIELD OF THE INVENTION

The present disclosure generally relates to computer-implemented methods, systems comprising computer-readable media, and electronic devices for group payment routing and, more particularly, to routing group payments using an automated payment agreement, such as a smart contract, that mitigates risk using open banking (OB) data.

### BACKGROUND

When organizing a group event (like a vacation, concert, sporting event, or renting a space such as, e.g., an ice rink) or making a group payment for a product or service, the organizer faces significant risk. This is because the organizer must personally pay a large amount in the form of a deposit or a whole amount on behalf of the group under current payment systems. One or more participants will often express interest and cancel belatedly. Or even when people do arrive, current systems require manually keeping track of who has paid and who owes. Further, last minute changes to a plan or price creates an additional burden on the organizer.

This background discussion is intended to provide information related to the present invention which is not necessarily prior art.

### BRIEF SUMMARY

Embodiments of the present technology relate to computer-implemented methods, systems comprising computer-readable media, and electronic devices for routing group payments using an automated payment agreement, such as a smart contract, that mitigates risk using OB data. The embodiments provide technological mechanisms for forming an automated payment agreement, such as a smart contract, pinpointing participants with low likelihoods of paying on time, and mitigating the risks with additional funds and/or determining an alternative payment date. Namely, embodiments of the present invention include forming at one or more financial technology service provider devices an automated payment agreement with terms that account for risk based on OB data. Embodiments of the present invention include using a smart contract stored on a ledger, determining an optimal payment date based on OB data of the participants, and/or delaying a group payment based on the OB data.

More particularly, in an aspect, a computer-implemented method for routing a group payment based upon OB data may be provided. The method may include: receiving, via one or more processors and/or transceivers associated with a financial technology service provider from one or more devices associated with an organizer of the group payment, terms of an automated payment agreement. The terms may include an execution date of the group payment, an amount apportioned to each participant of the group payment, and contact information of each participant of the group payment. The method may further include generating, via the one or more processors and/or transceivers associated with the financial technology service provider, an automated payment agreement having the terms; transmitting, via the one or more processors and/or transceivers associated with the financial technology service provider, the terms of the automated payment agreement to each participant device using the contact information of each participant of the group payment; receiving, via the one or more processors and/or transceivers associated with the financial technology service provider from one or more devices associated with an OB service provider, a proposed alternative date on which to withdraw the amount apportioned to one or more participants of the group payment and on which a likelihood of sufficient funds is higher than a likelihood of sufficient funds on the execution date for the one or more participants based at least in part on the OB data associated with the one or more of the participants; receiving, via the one or more processors and/or transceivers associated with the financial technology service provider from the one or more devices associated with the organizer of the group payment, an acceptance of the proposed alternative date; and transmitting, via the one or more processors and/or transceivers associated with the financial technology service provider to one or more devices associated with a selected financial institution serving the one or more participants, a request to draw funds on the proposed alternative date. The method may include additional, less, or alternate actions, including those discussed elsewhere herein.

A computer-implemented method for mitigating an indication of insufficient funds associated with one or more participants of a group payment based upon OB data according to another embodiment includes receiving, via one or more processors and/or transceivers associated with an OB service provider from selected financial institutions associated with participants of the group payment, the OB data associated with each participant of the group payment; receiving, via the one or more processors and/or transceivers associated with the OB service provider from one or more devices associated with a financial technology service provider, an execution date of the group payment; determining, via the one or more processors associated with the OB service provider, a first preferred value associated with each participant of the group payment based upon the OB data. The first preferred value represents a likelihood that an account with the selected financial institution of the corresponding participant will have sufficient funds to pay an amount of the group payment apportioned to the corresponding participant on the execution date. The method may further include determining, via the one or more processors associated with the OB service provider, a proposed alternative date on which to execute payment of the amount of the group payment apportioned to one or more of the participants and having a second preferred value that is higher than the first preferred value; and transmitting, via one or more processors and/or transceivers associated with an OB service provider to the one or more devices associated with the financial technology service provider, the proposed alternative date on which to execute payment of the amount of the group payment apportioned to the one or more of the participants. The method may include additional, less, or alternate actions, including those discussed elsewhere herein.

A computer-implemented method for mitigating an indication of insufficient funds associated with one or more participants of a group payment based upon OB data according to another embodiment includes receiving, via one or more processors and/or transceivers associated with a financial technology service provider from one or more devices associated with an organizer of the group payment, terms of a smart contract. The terms may include an execution date of the group payment, an amount apportioned to each participant of the group payment, and contact information of each participant of the group payment. The method may further include generating, via the one or more processors and/or transceivers associated with the financial technology service provider, the smart contract having the terms; storing, via the one or more processors and/or transceivers associated with the financial technology service provider, the smart contract on a digital ledger; and transmitting, via the one or more processors and/or transceivers associated with the financial technology service provider, the terms of the smart contract to each participant device using the contact information of each participant of the group payment. The method may include additional, less, or alternate actions, including those discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 illustrates various components, in block schematic form, of an exemplary system for routing group payments using an automated payment agreement that mitigates risk using OB data in accordance with embodiments of the present invention;

FIGS. 2, 3, 4, 5, and 6 illustrate various components of exemplary computing devices shown in block schematic form that may be used with the system of FIG. 1;

FIG. 7 is a flowchart of exemplary systems and components thereof for routing group payments using an automated payment agreement that mitigates risk using OB data, in accordance with embodiments of the present invention;

FIG. 8 illustrates at least a portion of the steps of an exemplary computer-implemented method for routing group payments using an automated payment agreement that mitigates risk using OB data in accordance with embodiments of the present invention;

FIG. 9 illustrates at least a portion of the steps of an exemplary computer-implemented method for mitigating risk of a group payment using OB data in accordance with embodiments of the present invention; and

FIG. 10 illustrates at least a portion of the steps of an exemplary computer-implemented method for routing group payments using an automated payment agreement that mitigates risk using OB data in accordance with another embodiment of the present invention.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

According to embodiments of the present invention, a technological mechanism is provided for routing a group payment using an automated payment agreement, such as a smart contract, funding the automated payment agreement through accounts of participants of the group payment, mitigating risks associated with the automated payment agreement, and executing the automated payment agreement on an execution date and/or delaying the payment by one or more participants based on open banking (OB) data. The embodiments include obtaining from an OB service provider system a likelihood of successful execution of the automated payment agreement, flagging any participant that has a low likelihood of having necessary funds available to execute their portion of the automated payment agreement upon the execution date based upon their respective OB data, determining an optimal date upon which to withdraw the necessary funds based on the OB data, and sending a request for consent regarding the optimal date and/or for additional payment authorizations from the rest of the participants to cover the deficient participant.

### EXEMPLARY SYSTEM

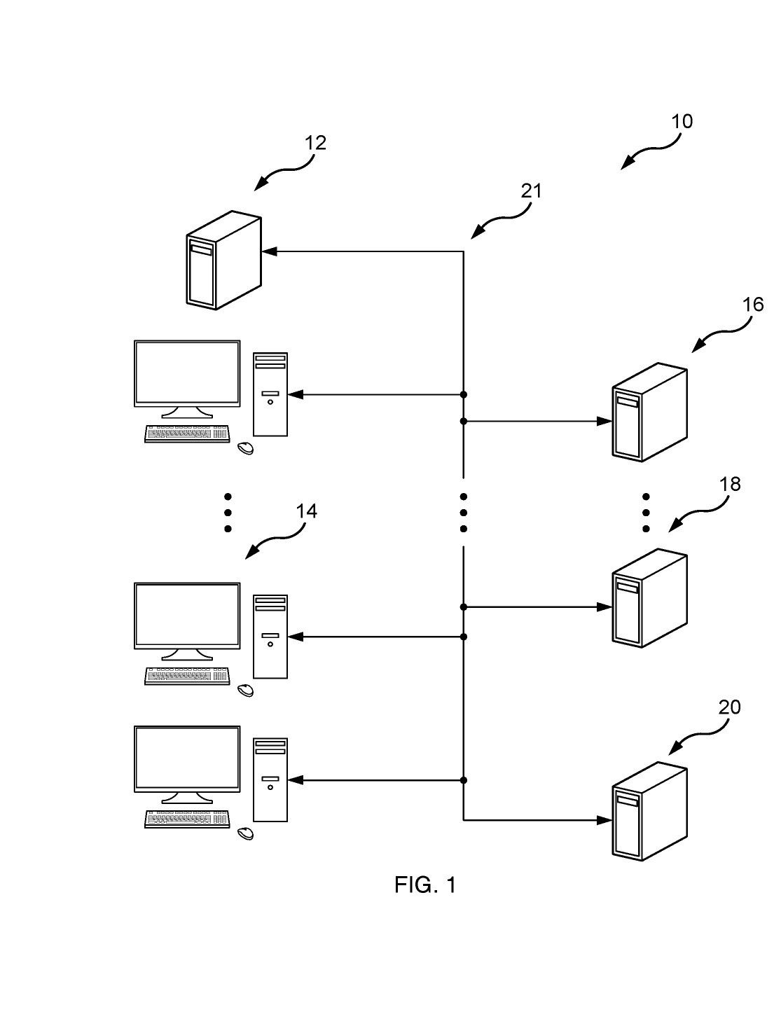

FIG. 1 depicts an exemplary environment 10 for routing group payments using an automated payment agreement that mitigates risk using OB data, according to embodiments of the present invention. The environment 10 may include one or more organizer devices 12, one or more participant devices 14, one or more financial technology service provider devices 16, one or more OB service provider devices 18, one or more financial institution devices 20, and a communication network 21.

The communication network 21 may be in communication via transmissions, at least in part, across public/semi-public telecommunication network infrastructure, with the communication network 21 being at least in part comprised of such public/semi-public telecommunication network infrastructure.

All or some of the devices 12, 14, 16, 18, 20 and/or all or some of the virtual resources managed thereby, may at least partly comprise a secure network computing environment. Alternatively or in addition, the financial technology service provider devices 16 may manage access and transmissions between and among itself and the other devices 12, 14, 18, 20 under an authentication management framework. For example, each user of organizer and/or participant devices 12, 14 may be required to complete an authentication process to access secure data provided via the financial technology service provider devices 16 and/or the services provided by and/or to OB service provider devices 18 and/or financial institution devices 20. In one or more embodiments, any authentication management framework may be utilized including, without limitation, custom frameworks.

For example, the OB service provider device 18 may host, aggregate and analyze data and host and provide access to/use of applications comprising open banking services. In one or more embodiments, the open banking services comprise data aggregation, analysis, management and data sharing services whereby consumers and businesses may subscribe for consented and controlled sharing of data with financial service providers and/or institutions.

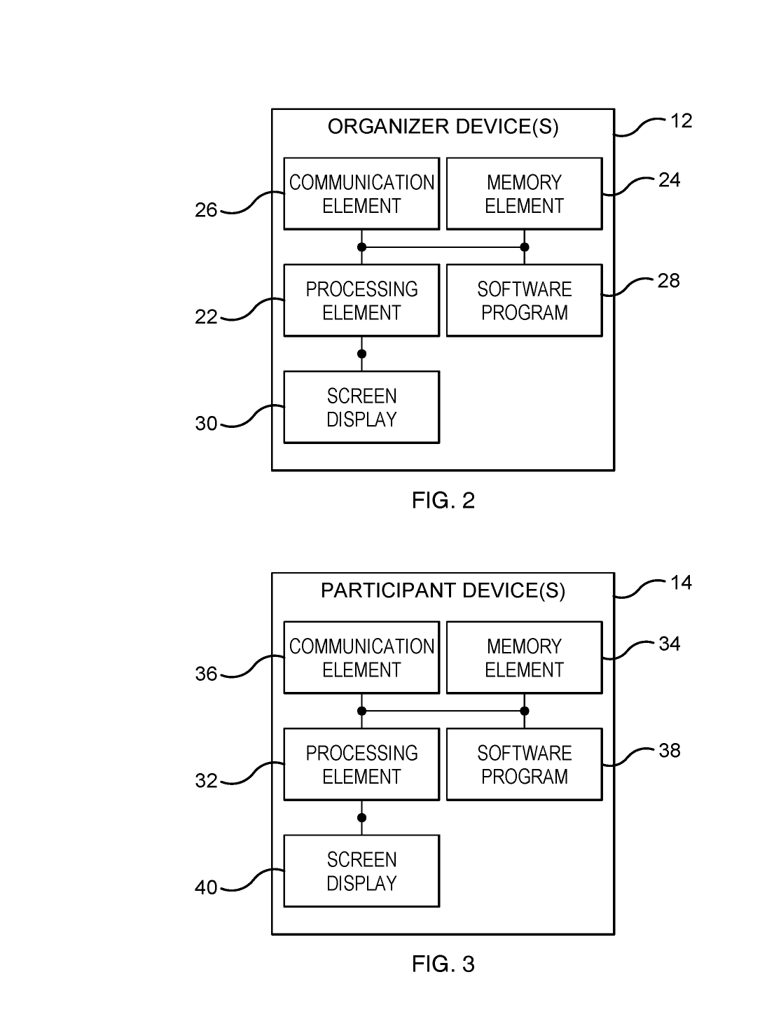

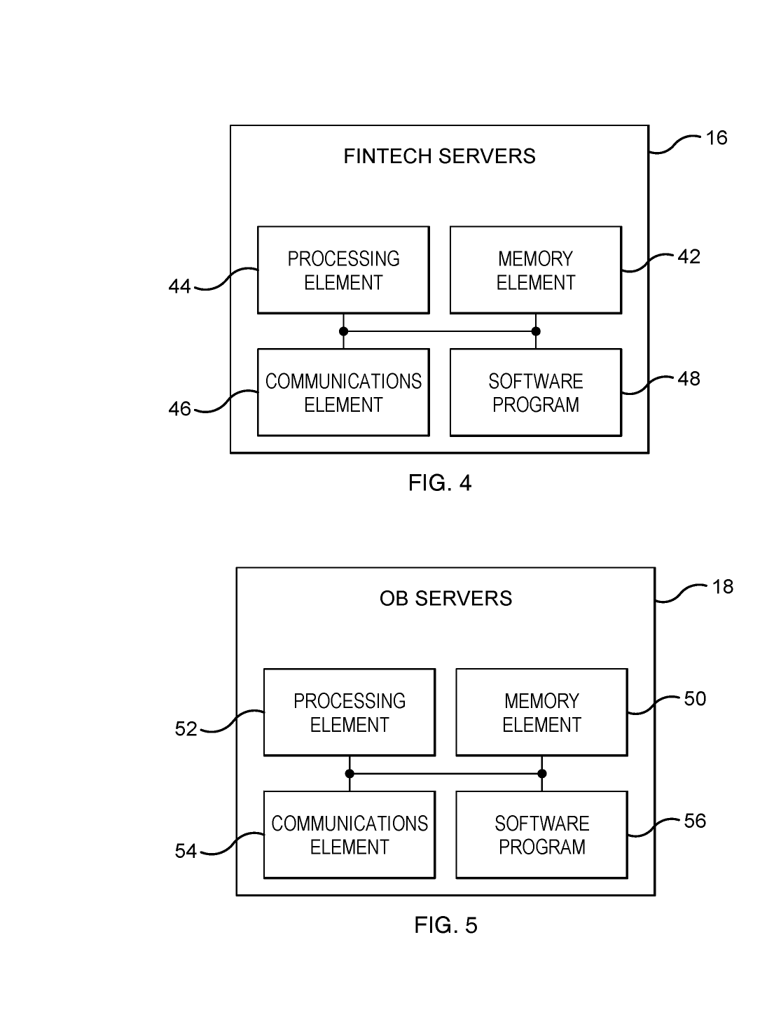

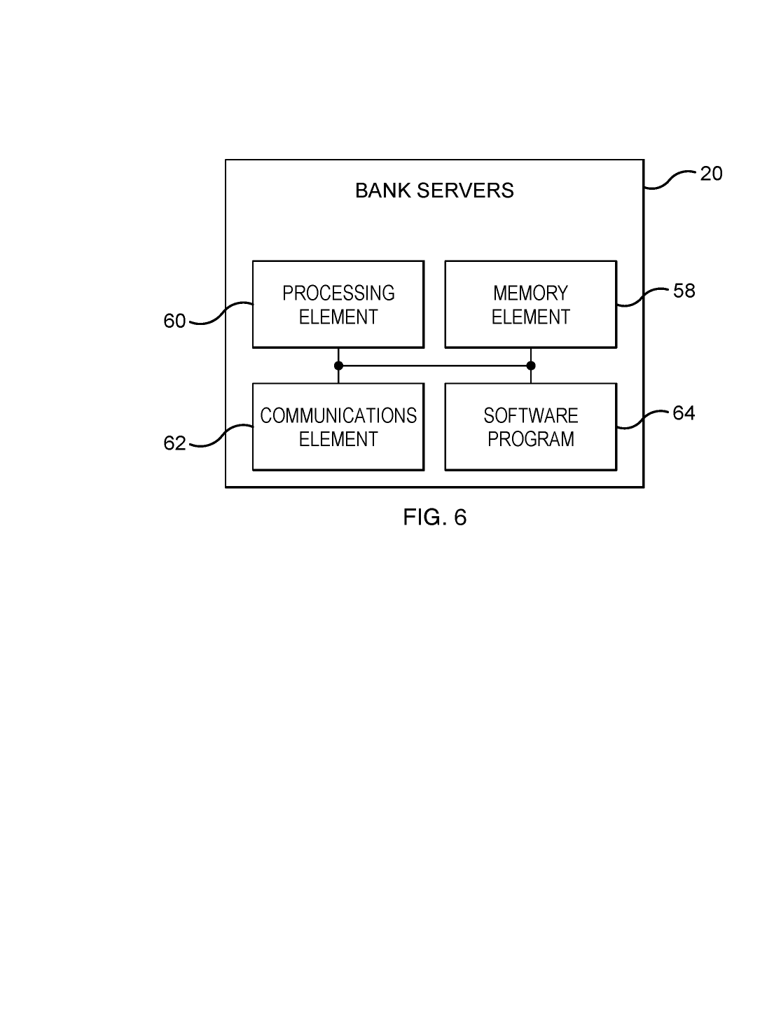

Turning to FIGS. 2-6, generally the organizer device 12 may include tablet computers, laptop computers, desktop computers, workstation computers, smart phones, smart watches, servers, and the like. In one or more embodiments, the participant devices 14 may include tablet computers, laptop computers, desktop computers, workstation computers, smart phones, smart watches, and the like. In one or more embodiments, the organizer device 12 may also be a participant device 14. For example, if the organizer also intends to participate in a group payment/event. In one or more embodiments, the financial technology service provider device 16, OB service provider device 18, and financial institution device 20 may comprise server(s), examples of which are discussed in more detail below.

Organizer device(s) 12 and participant devices 14 may each respectively include a processing element 22, 32, a memory element 24, 34, and circuitry capable of wired and/or wireless communication with the communication network 21, including, for example, a transceiver or communication element 26, 36. Each of the organizer and participant devices 12, 14 may additionally include a screen display 30, 40, which may comprise a user interface. The displays 30, 40 may include video devices of any of the following types: plasma, standard or ultra-high-definition light-emitting diode (LED), organic LED (OLED), quantum dot LED (QLED), Light Emitting Polymer (LEP) or Polymer LED (PLED), liquid crystal display (LCD), thin film transistor (TFT) LCD, LED side-lit or back-lit LCD, or the like, or combinations thereof. The displays 30, 40 may possess a square or a rectangular aspect ratio and may be viewed in either a landscape or a portrait mode. In various embodiments, the displays 30, 40 may also include a touch screen occupying all or part of the screen.

Further, each of the organizer devices 12 and the participant device 14 may include a software application or program 28, 38 configured with instructions for performing and/or enabling performance of at least some of the steps set forth herein. In an embodiment, the software programs 28, 38 each comprises instructions respectively stored on computer-readable media of a memory element 24, 34.

The OB service provider devices 18 generally receive requests for open banking data sharing directly or indirectly from the participant devices 14 and/or the financial institution devices 20, optionally manage a consent process for obtaining consent for such sharing from data subjects, and expose or otherwise provide such open banking data to the financial technology service provider device 16.

The OB service provider devices 18 may comprise cloud servers, domain controllers, application servers, database servers, database web servers, file servers, mail servers, catalog servers or the like, or combinations thereof. In one or more embodiments, one or more data sources may be maintained by one or more of the OB service provider devices 18.

Generally, each server 16, 18, 20 may include a memory element 42, 50, 58, a processing element 44, 52, 60, a communication element 46, 54, 62, and a software program 48, 56, 64.

The communication network 21 generally allows communication between the organizer device 12, the participant device 14, the financial technology service provider devices 16, the OB service provider devices 18, and the financial institution devices 20, for example in conjunction with device enrollment, data acquisition, and data consenting.

The communication network 21 may include the Internet, cellular communication networks, local area networks, metro area networks, wide area networks, cloud networks, plain old telephone service (POTS) networks, and the like, or combinations thereof. The communication network 21 may be wired, wireless, or combinations thereof and may include components such as modems, gateways, switches, routers, hubs, access points, repeaters, towers, and the like. The organizer device 12, the participant devices 14, the financial technology service provider devices 16, the OB service provider devices 18, and/or the financial institution devices 20 may, for example, connect to the communication network 21 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication elements 26, 36, 46, 54, 62 generally allow communication between the organizer device 12, the participant devices 14, the financial technology service provider devices 16, the OB service provider devices 18, the financial institution devices 20, and/or the communication network 21. The communication elements 26, 36, 46, 54, 62 may include signal or data transmitting and receiving circuits, such as antennas, amplifiers, filters, mixers, oscillators, digital signal processors (DSPs), and the like. The communication elements 26, 36, 46, 54, 62 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the communication elements 26, 36, 46, 54, 62 may utilize communication standards such as ANT, ANT+, Bluetooth™ low energy (BLE), the industrial, scientific, and medical (ISM) band at 2.4 gigahertz (GHz), or the like. Alternatively, or in addition, the communication elements 26, 36, 46, 54, 62 may establish communication through connectors or couplers that receive metal conductor wires or cables, like Cat 6 or coax cable, which are compatible with networking technologies such as ethernet. In certain embodiments, the communication elements 26, 36, 46, 54, 62 may also couple with optical fiber cables. The communication elements 26, 36, 46, 54, 62 may respectively be in communication with the processing elements 22, 32, 44, 52, 60 and/or the memory elements 24, 34, 42, 50, 58.

The memory elements 24, 34, 42, 50, 58 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory elements 24, 34, 42, 50, 58 may be embedded in, or packaged in the same package as, the processing elements 22, 32, 44, 52, 60. The memory elements 24, 34, 42, 50, 58 may include, or may constitute, a “computer-readable medium.” The memory elements 24, 34, 42, 50, 58 may store the instructions, code, code segments, software, firmware, programs, applications, apps, services, daemons, or the like that are executed by the processing elements 22, 32, 44, 52, 60. In an embodiment, the memory elements 24, 34, 42, 50, 58 respectively store the software applications/programs 28, 38, 48, 56, 64. The memory elements 24, 34, 42, 50, 58 may also store settings, data, documents, sound files, photographs, movies, images, databases, and the like.

The processing elements 22, 32, 44, 52, 60 may include electronic hardware components such as processors. The processing elements 22, 32, 44, 52, 60 may include digital processing unit(s). The processing elements 22, 32, 44, 52, 60 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing elements 22, 32, 44, 52, 60 may generally execute, process, or run instructions, code, code segments, software, firmware, programs, applications, apps, processes, services, daemons, or the like. For instance, the processing elements 22, 32, 44, 52, 60 may respectively execute the software applications/programs 28, 38, 48, 56, 64. The processing elements 22, 32, 44, 52, 60 may also include hardware components such as finite-state machines, sequential and combinational logic, and other electronic circuits that can perform the functions necessary for the operation of embodiments of the current invention. The processing elements 22, 32, 44, 52, 60 may be in communication with the other electronic components through serial or parallel links that include universal busses, address busses, data busses, control lines, and the like.

Data sources hosted by the OB service provider devices 18 may utilize a variety of formats and structures within the scope of the invention. For instance, relational databases and/or object-oriented databases may embody the data sources and may be exposed for queries by one or more corresponding APIs. One of ordinary skill will appreciate that – while examples presented herein may discuss specific types of operating systems and/or databases – a wide variety may be used alone or in combination within the scope of the present invention.

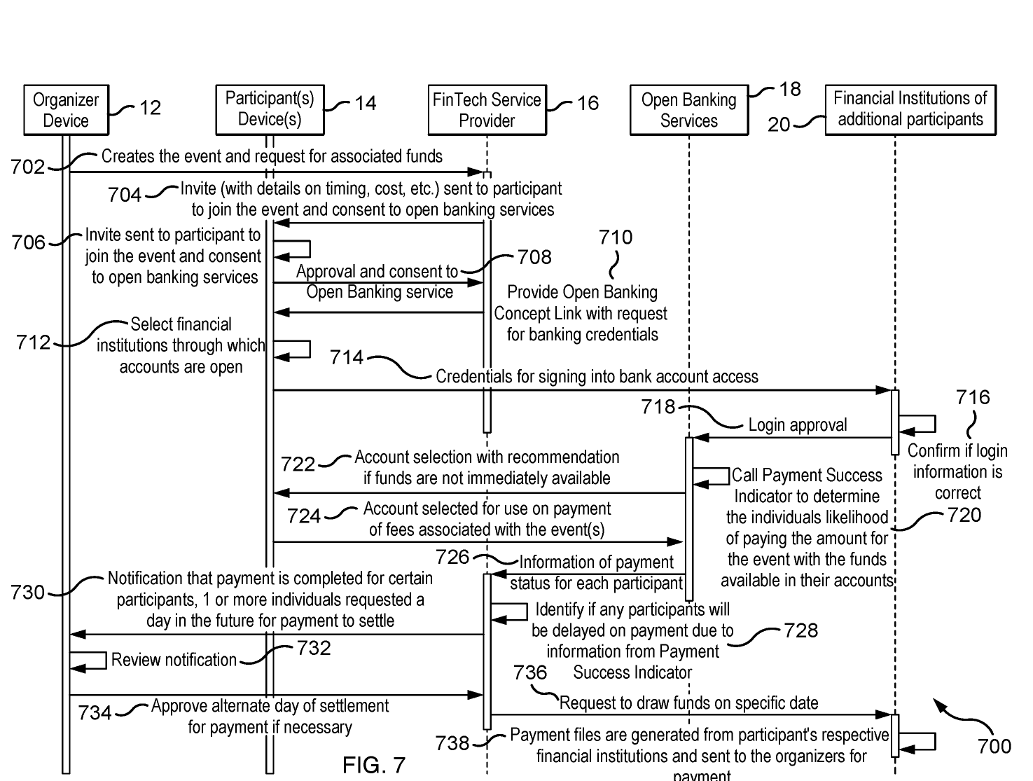

Turning to FIG. 7, a sequence diagram 700 for routing group payments using an automated payment agreement that mitigates risk using OB data implemented in embodiments of the system 10 described herein.

The organizer device 12 receives, via one or more user inputs, terms of an automated payment agreement. In one or more embodiments, the terms comprise an identifier of the group payment/event, an execution date of the group payment, an amount of the group payment, an amount apportioned to each participant, an additional amount to be authorized by each participant, and contact information of each participant of the group payment. In one or more embodiments, the automated payment agreement includes terms for a recurring group payment with a recurring amount apportioned to each participant for the recurring group payment and terms related to timing of the execution of the recurring group payments (e.g., daily payments, weekly payments, monthly payments, etc.). Once the desired terms have been input, the organizer device 12 is configured to transmit 702 the terms in the form of a request to the financial technology service provider device 16, which receives the terms of the automated payment agreement.

The financial technology service provider device 16 is configured to generate the automated payment agreement having the terms. In one or more embodiments, the automated payment agreement is a smart contract. In one or more embodiments, the financial technology service provider device 16 is configured to store the smart contract on a digital ledger, such as on its memory element 42. In one or more embodiments, the financial technology service provider device 16 is configured to store the smart contract on a distributed ledger, such as on a blockchain, as described in U.S. Patent No. 11,558,173, which is hereby incorporated by reference herein.

The financial technology service provider device 16 is configured to transmit 704 the terms of the automated payment agreement to the participant devices 14 using the contact information of each participant of the group payment. In one or more embodiments, the contact information includes a cell phone number, an email address, an account username associated with an application, or the like. The terms may include an invite to participate in the group payment and/or group event as well as a request for consent to participate in OB services. In one or more embodiments, the invitation further includes a link for connecting banking accounts of each participant to an OB service provider. However, the link may be sent later in the sequence, as discussed below. In one or more embodiments, the invitation can be shared 706 among participant devices 14.

The participant devices 14 are configured to transmit 708 an indication of assent to the terms of the automated payment agreement and/or to OB services to the financial technology service provider device 16. In one or more embodiments, the participant devices 14 receive assent from the participant via user inputs of the user interface of the participant devices 14. The assent may include a selection of one or more predefined options for how to apply the additional amount. For example, the options may include pooling the additional amounts in a group fund, covering one or more participants’ portion of the group payment, etc. However, this selection may be made at a different point in the sequence without departing from the scope of the present invention.

The financial technology service provider device 16 is configured to transmit 710 a link, such as a uniform resource locator (URL), associated with OB services to each participant device 14 assenting to the group payment, as described in U.S. Patent No. 11,669,834, which is hereby incorporated by reference herein. The link may include a request for banking credentials, including a selection of a financial institution and an account at the institution.

The participant devices 14 may be configured to receive 712 and transmit 714 the login credentials for the selected account with the selected financial institution to the corresponding financial institution device 20. The financial institution device 20 is configured to confirm 716 the login credentials and transmit 718 login approval to the OB service provider device 18. The login approval may also include transmittal of OB data and/or access to OB data.

The OB data may be accessed by an OB service such as that offered under the registered mark FINICITY® of Finicity Corporation as of the initial filing date of the present disclosure. Such features may include, without limitation, features for and comprising an OB platform configured to manage cardholder payments, gain insight into spending trends and recommendations, manage finances and otherwise direct customary OB functions.

For example, in one or more embodiments, the one or more of the device(s) is/are configured to enable OB service provider device 18 and/or financial technology service provider device 16 access to banking records and account data of a putative payee, to retrieve and/or enable access to the account data, and/or perform other functions associated with OB.

More particularly, data subjects (e.g., consumers and businesses seeking financial services from financial service providers) may subscribe to the OB services and identify one or more financial accounts or data/documents sources from which to share data and/or directly provide copies of financial and identification information (e.g., access credentials) and documents. The data subjects may also consent to controlled sharing of such financial, identity- and/or location-related information with the OB services of the OB service device 18 and, in turn, with consented data recipients (e.g., the financial service providers).

In turn, data recipients (e.g., lenders, credit score agencies, credit card service providers, or other financial institutions or financial service providers) may subscribe and access the OB services and subject data, for example to calculate credit scores, open new financial accounts, provide advice about improving credit scores, approve loan requests from data subjects, and perform other financial services.

Each of these putative or completed financial transactions, account or data access events, or other OB operations, may comprise a digital interaction without departing from the spirit of the present invention.

The OB service provider device 18 is configured to determine 720 a preferred value associated with each participant of the group payment based upon the OB data. In one or more embodiments, the preferred value is associated with a likelihood that the account with the selected financial institution of the corresponding participant will have sufficient funds to pay a portion of the group payment apportioned to the corresponding participant on the execution date. In one or more embodiments, the OB service provider device 18 is configured to determine—based on the OB data—a proposed alternative date on which to execute payment of the portion of the group payment apportioned to one or more of the participants and on which a likelihood of sufficient funds is higher than a likelihood of sufficient funds on the execution date. The preferred value and/or proposed alternative date may be calculated using any of the processes, methods, algorithms, etc. disclosed in U.S. Patent Application Serial No. 18/814,735, which is hereby incorporated by reference herein.

In one or more embodiments, the OB service provider device 18 is configured to determine that one or more participants of the group payment do not immediately have sufficient funds to pay the portion of the group payment apportioned to the corresponding participant. The OB service provider device 18 may be configured to transmit 722 to the participant device 14 associated with the participant lacking sufficient funds a request for a secondary account for paying the portion of the group payment apportioned to the corresponding participant.

The corresponding participant device 14 may be configured to receive a selection of the secondary account through the user interface and transmit 724 the selection for the secondary account to the OB service provider device 18. The OB service provider device 18 may be configured to receive from the participant device 14 the selection of the secondary account and apply the payment authorization for the amount apportioned to the participant and/or the additional amount to the secondary account.

The OB service provider device 18 is configured to transmit 726 a payment status of each participant of the group payment to the financial technology service provider device 16. The payment status may include an indication as to whether each participant has had funds transferred from and/or payment authorizations placed on its corresponding account for the apportioned amount of the group payment and/or the additional amount. The OB service provider device 18 may also be configured to transmit the preferred value associated with each participant of the group payment and/or the proposed alternative date for executing the payment.

The financial technology service provider 16 is configured to determine 728 the participants that will likely need to pay on a proposed alternative date and transmit 730 a notification comprising the payment status of each payment and the proposed alternative date for one or more of the participants. The notification may include a request for approval of the proposed alternative date for one or more participants.

The organizer device 12 is configured to receive 732 the notification from the financial technology service provider device 16 and transmit 734 an indication of approval of the proposed alternative date for payment by one or more participants.

The financial technology service provider device 16 is configured to transmit 736 a request to draw funds on the execution date and/or the proposed alternative date. Alternatively or additionally, in one or more embodiments, upon a trigger event (such as a geolocation determination of the participant device 14 located within a certain distance of particular coordinates related to the group event, an opening of an application, a payment at a terminal, or the like), the participant devices 14 are configured to transmit a signal to the financial technology service provider device 16 for executing the automatic payment agreement, or smart contract, so that the funds are withdrawn for the amount apportioned to the user for the group payment and/or any additional amount. The participant device 14 may also be configured to prompt the participant to select one of the predefined options for directing the additional amount associated with the group event/payment. Upon receiving the instructions from the financial technology service provider device 16, the financial institution device(s) 20 are configured to direct 738 the funds to the organizer and/or apply the additional amounts to one or more of the predefined options.

### EXEMPLARY COMPUTER-IMPLEMENTED METHOD FOR ROUTING GROUP PAYMENTS USING AN AUTOMATED PAYMENT AGREEMENT THAT MITIGATES RISK USING OB DATA

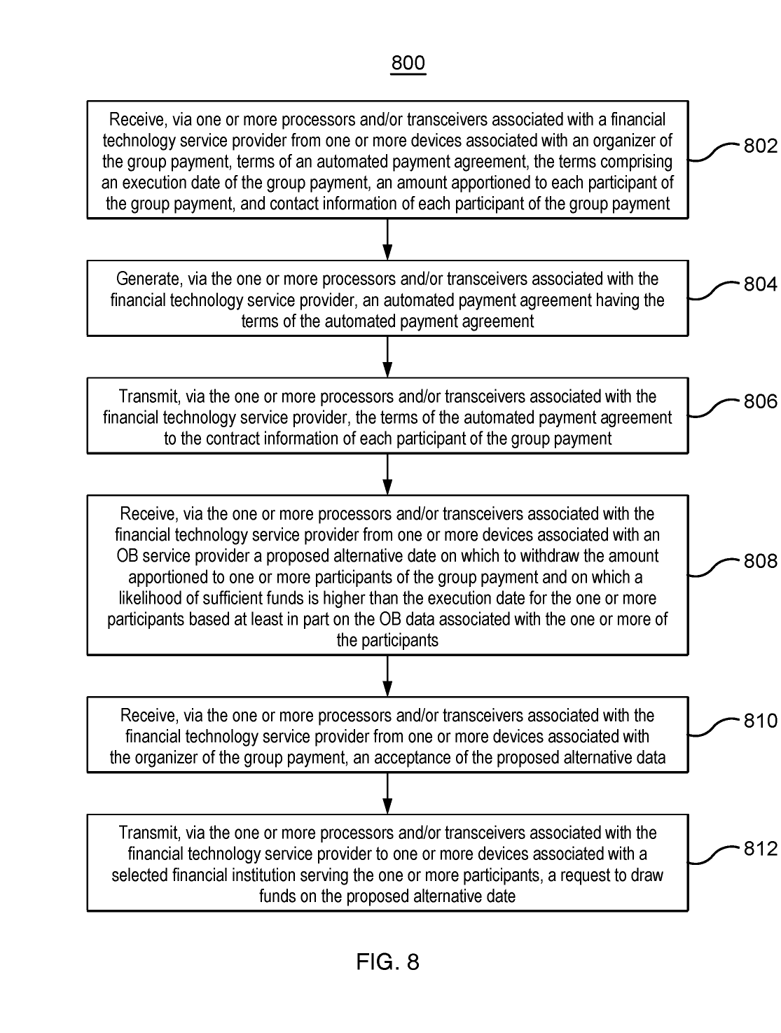

FIG. 8 depicts a flowchart including a listing of steps of an exemplary computer-implemented method 800 for routing a group payment that mitigates risk based upon OB data. The steps may be performed in the order shown in FIG. 8, or they may be performed in a different order. Furthermore, some steps may be performed concurrently as opposed to sequentially. In addition, some steps may be optional.

The computer-implemented method 800 is described below, for ease of reference, as being executed by exemplary devices and components introduced with the embodiments illustrated in FIGS. 1-7. For example, the steps of the computer-implemented method 800 may be performed by the financial technology service provider devices 16 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

As shown in FIG. 8, the method 800 may include receiving, via one or more processors and/or transceivers associated with a financial technology service provider from one or more devices associated with an organizer of the group payment, terms of an automated payment agreement (block 802). In one or more embodiments, the terms include an execution date of the group payment, an amount apportioned to each participant of the group payment, and contact information of each participant of the group payment. In one or more embodiments, the terms further include an additional amount apportioned to each participant of the group payment and options for direct the additional amount apportioned to each participant.

As also shown in FIG. 8, the method 800 may include generating, via the one or more processors and/or transceivers associated with the financial technology service provider, an automated payment agreement having the terms of the automated payment agreement (block 804). In one or more embodiments, the automated payment agreement includes a smart contract stored on a digital ledger, such as a centralized ledger system associated with the financial technology service provider and/or a distributed ledger system, such as a blockchain.

As further shown in FIG. 8, the method 800 may include transmitting, via the one or more processors and/or transceivers associated with the financial technology service provider, the terms of the automated payment agreement to the participant devices using the contact information of each participant of the group payment (block 806). As discussed above, the contact information may include a cell phone number, an email address, or the like. The transmission may be in the form of a message comprising text. In one of more embodiments, this step 806 includes receiving an indication of assent to the terms of the automated payment agreement and/or the use of OB service. This step 806 may also include transmitting a link, such as a URL, to a website associated with the OB service provider and/or a selected financial institution for entering banking login credentials.

As also shown in FIG. 8, the method 800 may include receiving, via the one or more processors and/or transceivers associated with the financial technology service provider from one or more devices associated with an OB service provider, a proposed alternative date on which to withdraw the amount apportioned to one or more participants of the group payment and on which a likelihood of sufficient funds is higher than the execution date for the one or more participants based at least in part on the OB data associated with the one or more of the participants (block 808). In one or more embodiments, this step includes receiving a payment status of each participant of the group payment and relaying the payment status and the proposed alternate date for one or more of the participants to the organizer device.

As further shown in FIG. 8, the method 800 may include receiving, via the one or more processors and/or transceivers associated with the financial technology service provider from the one or more devices associated with the organizer of the group payment, an acceptance of the proposed alternative date (block 810).

As also shown in FIG. 8, the method 800 may include transmitting, via the one or more processors and/or transceivers associated with the financial technology service provider to one or more devices associated with a selected financial institution serving the one or more participants, a request to draw funds on the proposed alternative date (block 812). In one or more embodiments, this step 812 also includes transmitting the request on the pre-defined execution date for the group payment.

### EXEMPLARY COMPUTER-IMPLEMENTED METHOD FOR MITIGATING RISK OF A GROUP PAYMENT USING OB DATA

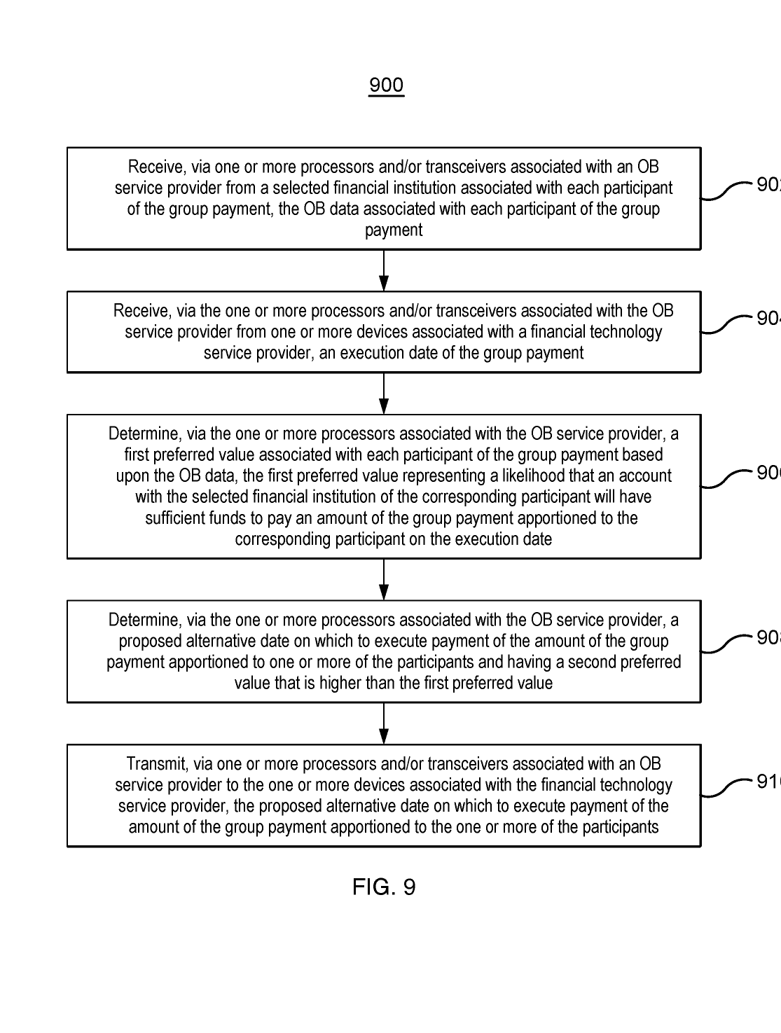

FIG. 9 depicts a flowchart including a listing of steps of an exemplary computer-implemented method 900 for mitigating risk of a group payment based upon OB data. The steps may be performed in the order shown in FIG. 9, or they may be performed in a different order. Furthermore, some steps may be performed concurrently as opposed to sequentially. In addition, some steps may be optional.

The computer-implemented method 900 is described below, for ease of reference, as being executed by exemplary devices and components introduced with the embodiments illustrated in FIGS. 1-7. For example, the steps of the computer-implemented method 900 may be performed by the OB service provider devices 18 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

As shown in FIG. 9, the method 900 may include receiving, via one or more processors and/or transceivers associated with an OB service provider from a selected financial institution associated with each participant of the group payment, the OB data associated with each participant of the group payment (block 902). This step 902 may include receiving a payment status and/or an amount of funds available in a selected account from the financial institution device.

As also shown in FIG. 9, the method 900 may include receiving, via the one or more processors and/or transceivers associated with the OB service provider from one or more devices associated with a financial technology service provider, an execution date of the group payment (block 904). This step 904 may include receiving terms of an automated payment agreement and/or an identifier of a smart contract on a distributed ledger, such as a blockchain.

As further shown in FIG. 9, the method 900 may include determining, via the one or more processors associated with the OB service provider, a first preferred value associated with each participant of the group payment based upon the OB data. As discussed above, the first preferred value represents a likelihood that an account with the selected financial institution of the corresponding participant will have sufficient funds to pay an amount of the group payment apportioned to the corresponding participant on the execution date (block 906). In one or more embodiments, this step 906 includes determining whether each participant has sufficient funds in the selected account to pay the amount apportioned to each participant and/or the additional amount. In one or more embodiments, this step 906 includes transmitting to one or more devices associated with the one or more participants of the group payment a request for a secondary account. This step 906 may further include receiving from the participant devices a selection of the secondary account.

As also shown in FIG. 9, the method 900 may include determining, via the one or more processors associated with the OB service provider, a proposed alternative date on which to execute payment of the amount of the group payment apportioned to one or more of the participants and having a second preferred value that is higher than the first preferred value (block 908).

As further shown in FIG. 9, the method 900 may include transmitting, via one or more processors and/or transceivers associated with an OB service provider to the one or more devices associated with the financial technology service provider, the proposed alternative date on which to execute payment of the amount of the group payment apportioned to the one or more of the participants (block 910). In one or more embodiments, this step 910 includes transmitting the payment status of each participant and the preferred value of each participant.

### EXEMPLARY COMPUTER-IMPLEMENTED METHOD FOR ROUTING GROUP PAYMENTS USING AN AUTOMATED PAYMENT AGREEMENT THAT MITIGATES RISK USING OB DATA

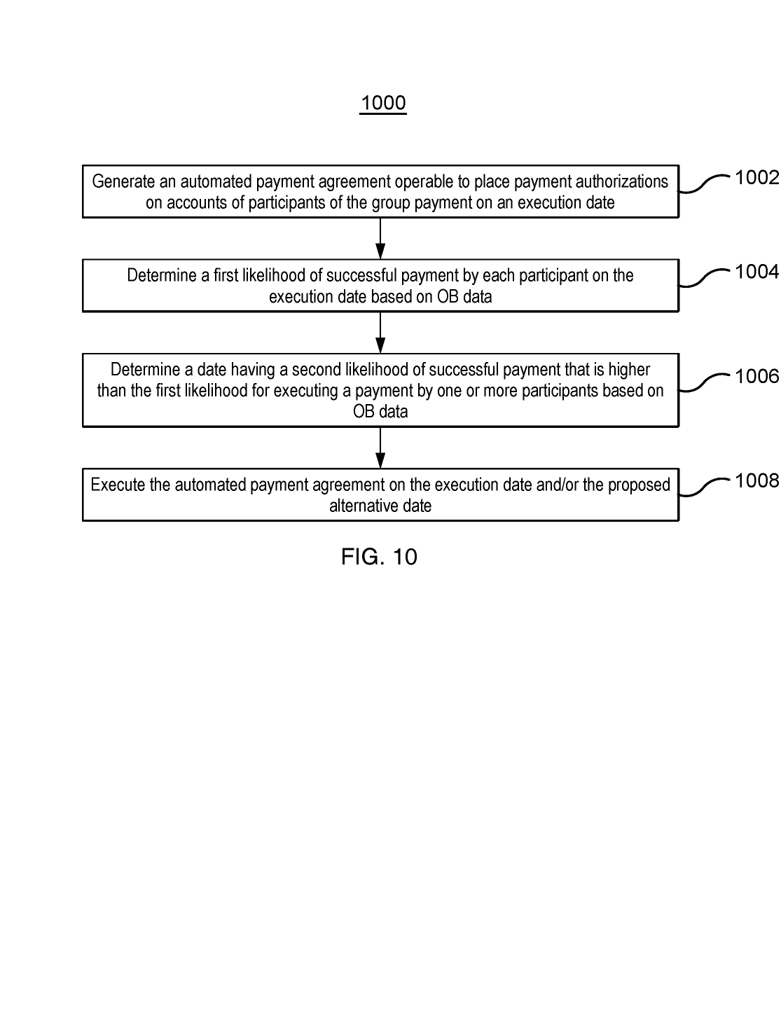

FIG. 10 depicts a flowchart including a listing of steps of an exemplary computer-implemented method 1000 for routing a group payment that mitigates risk based upon OB data. The steps may be performed in the order shown in FIG. 10, or they may be performed in a different order. Furthermore, some steps may be performed concurrently as opposed to sequentially. In addition, some steps may be optional.

The computer-implemented method 1000 is described below, for ease of reference, as being executed by exemplary devices and components introduced with the embodiments illustrated in FIGS. 1-7. For example, the steps of the computer-implemented method 1000 may be performed by the organizer device 12, the participant devices 14, the financial technology service provider devices 16, the OB service provider devices 18, the financial institution devices 20, and/or the network 21 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

As shown in FIG. 10, the method 1000 may include generating an automated payment agreement operable to place payment authorizations on accounts of participants of the group payment on an execution date (block 1002). The organizer device may receive, via one or more user inputs, terms of an automated payment agreement. As discussed above, the terms may comprise an identifier of the group payment/event, an execution date of the group payment, an amount of the group payment, an amount apportioned to each participant, an additional amount to be authorized by each participant, and contact information of each participant of the group payment. In one or more embodiments, the automated payment agreement includes terms for a recurring group payment with a recurring amount apportioned to each participant for the recurring group payment. Once the desired terms have been input, the organizer device may transmit the terms in the form of a request to the financial technology service provider device, which receives the terms of the automated payment agreement.

The financial technology service provider device generates the automated payment agreement having the terms. In one or more embodiments, the automated payment agreement is a smart contract. In one or more embodiments, the financial technology service provider device stores the smart contract on a digital ledger, such as on its memory element. In one or more embodiments, the financial technology service provider device stores the smart contract on a distributed ledger, such as on a blockchain.

This step 1002 may include the financial technology service provider device transmitting the terms of the automated payment agreement to the participant devices using the contact information of each participant of the group payment. As discussed above, the contact information may include a cell phone number, an email address, an account username associated with an application, or the like. The terms may include an invite to participate in the group payment and/or group event as well as a request for consent to participate in OB services. In one or more embodiments, the invitation further includes a link for connecting banking accounts of each participant to the OB service provider. However, the link may be sent later in the method 1000, as discussed below. In one or more embodiments, the invitation can be shared among participant devices.

This step 1002 may further include the participant devices transmitting an indication of assent to the terms of the automated payment agreement and/or to OB services to the financial technology service provider device. In one or more embodiments, the participant devices receive assent from the participant via user inputs of the user interface of the participant devices. The assent may include a selection of one or more predefined options for how to apply the additional amount. For example, the options may include pooling the additional amounts in a group fund, covering one or more participants’ portion of the group payment, etc. However, this selection may be made at a different point in the sequence without departing from the scope of the present invention.

This step 1002 may further include the financial technology service provider device transmitting a link, such as a uniform resource locator (URL), associated with OB services to each participant device assenting to the group payment. The link may include a request for banking credentials, including a selection of a financial institution and an account at the institution.

This step 1002 may further include the participant devices receiving and transmitting the login credentials for the selected account with the selected financial institution to the corresponding financial institution device. The financial institution device may confirm the login credentials and transmit login approval to the OB service provider device. The login approval may also include transmittal of OB data and/or access to OB data.

As also shown in FIG. 10, the method 1000 may include determining a first likelihood of successful payment by each participant on the execution date based on OB data (block 1004). The OB service provider device may determine a preferred value associated with each participant of the group payment based upon the OB data. As discussed above, the preferred value is associated with a likelihood (i.e., the first likelihood) that the account with the selected financial institution of the corresponding participant will have sufficient funds to pay a portion of the group payment apportioned to the corresponding participant on the execution date.

This step 1004 may further include the OB service provider device determining that one or more participants of the group payment do not immediately have sufficient funds to pay the portion of the group payment apportioned to the corresponding participant. The OB service provider device may transmit to the participant device associated with the participant lacking sufficient funds a request for a secondary account for paying the portion of the group payment apportioned to the corresponding participant.

This step 1004 may further include the corresponding participant device receiving a selection of the secondary account through the user interface and transmitting the selection of the secondary account to the OB service provider device. The OB service provider device may receive from the participant device the selection of the secondary account and apply the payment authorization for the amount apportioned to the participant and/or the additional amount to the secondary account.

This step 1004 may further include the OB service provider device transmitting a payment status of each participant of the group payment to the financial technology service provider device. The payment status may include an indication as to whether each participant has had funds transferred from and/or payment authorizations placed on its corresponding account for the apportioned amount of the group payment and/or the additional amount. The OB service provider device may also transmit the preferred value associated with each participant of the group payment.

As further shown in FIG. 10, the method 1000 may include determining a date having a second likelihood of successful payment that is higher than the first likelihood for executing a payment by one or more participants based on OB data (block 1006). In one or more embodiments, the OB service provider device determines, based on the OB data, a proposed alternative date on which to execute payment of the portion of the group payment apportioned to one or more of the participants and on which a likelihood (i.e., the second likelihood) of sufficient funds is higher than on the execution date (i.e., the first likelihood).

This step 1006 may further include the financial technology service provider determining which of the participants will likely need to pay on a proposed alternative date and transmitting a notification comprising the payment status of each payment and the proposed alternative date for one or more of the participants. The notification may include a request for approval of the proposed alternative date for one or more participants. The organizer device may receive the notification from the financial technology service provider device and transmit an indication of approval of the proposed alternative date for payment by one or more participants.

As also shown in FIG. 10, the method 1000 may include execute the automated payment agreement on the execution date and/or the proposed alternative date (block 1008). In one or more embodiments, this step 1008 includes the financial technology service provider device transmitting a request to draw funds on the execution date and/or the proposed alternative date. Alternatively or additionally, in one or more embodiments, upon a trigger event (such as a geolocation determination of the participant device located within a certain distance of particular coordinates related to the group event, an opening of an application, a payment at a terminal, or the like), the participant devices transmit a signal to the financial service provider device for executing the automatic payment agreement, or smart contract, so that the funds are withdrawn for the amount apportioned to the user for the group payment and/or any additional amount. The participant device may also prompt the participant to select one of the predefined options for directing the additional amount associated with the group event/payment. This step 1008 may include, upon receiving the instructions from the financial service provider device, the financial institution device(s) directing the funds to the organizer and/or applying the additional amounts to one or more of the predefined options.

### ADDITIONAL CONSIDERATIONS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A computer-implemented method for routing a group payment based upon open banking (OB) data, the computer-implemented method comprising:
receiving, via one or more processors and/or transceivers associated with a financial technology service provider from one or more devices associated with an organizer of the group payment, terms of an automated payment agreement, the terms comprising an execution date of the group payment, an amount apportioned to each participant of the group payment, and contact information of each participant of the group payment;
generating, via the one or more processors and/or transceivers associated with the financial technology service provider, an automated payment agreement having the terms;
transmitting, via the one or more processors and/or transceivers associated with the financial technology service provider, the terms of the automated payment agreement to each participant device using the contact information of each participant of the group payment;
receiving, via the one or more processors and/or transceivers associated with the financial technology service provider from one or more devices associated with an OB service provider, a proposed alternative date on which to withdraw the amount apportioned to one or more participants of the group payment and on which a likelihood of sufficient funds is higher than a likelihood of sufficient funds on the execution date for the one or more participants based at least in part on the OB data associated with the one or more of the participants;
receiving, via the one or more processors and/or transceivers associated with the financial technology service provider from the one or more devices associated with the organizer of the group payment, an acceptance of the proposed alternative date; and
transmitting, via the one or more processors and/or transceivers associated with the financial technology service provider to one or more devices associated with a selected financial institution serving the one or more participants, a request to draw funds on the proposed alternative date.

2. The computer-implemented method of claim 1, wherein the automated payment agreement comprises a smart contract stored on one or more digital ledgers.

3. The computer-implemented method of claim 2, wherein the one or more digital ledgers is a centralized ledger associated with the financial technology service provider.

4. The computer-implemented method of claim 2, wherein the one or more digital ledgers is a distributed ledger system.

5. The computer-implemented method of claim 1, wherein the terms of the automated payment agreement include an additional amount apportioned to each participant of the group payment, further comprising receiving, via the one or more processors and/or transceivers associated with the financial technology service provider, an instruction on how to direct the additional amount apportioned to each participant from one or more of the participants.

6. The computer-implemented method of claim 1, further comprising:
receiving, via the one or more processors and/or transceivers associated with the financial technology service provider from one or more devices associated with each of the participants of the group payment, an indication of assent to the terms of the automated payment agreement and to OB services; and
transmitting, via the one or more processors and/or transceivers associated with the financial technology service provider to the one or more devices associated with each of the participants of the group payment, a uniform resource locator associated with the OB services provider to each participant of the group payment.

7. The computer-implemented method of claim 1, further comprising:
receiving, via the one or more processors and/or transceivers associated with the financial technology service provider from one or more devices associated with the OB service provider, a payment status of each participant of the group payment; and
transmitting, via the one or more processors and/or transceivers associated with the financial technology service provider to the one or more devices associated with the organizer of the group payment, a notification comprising the payment status of each participant of the group payment.

8. The computer-implemented method of claim 1, further comprising transmitting, via the one or more processors and/or transceivers associated with the financial technology service provider to the one or more processors and/or transceivers associated with the organizer of the group payment, a notification comprising the proposed alternative date.

9. The computer-implemented method of claim 1, further comprising:
receiving, via one or more processors and/or transceivers associated with the OB service provider, the OB data associated with each participant of the group payment from their respective selected financial institution;
determining, via the one or more processors associated with the OB service provider, a preferred value associated with each participant of the group payment based upon the OB data, the preferred value associated with a likelihood that an account with the selected financial institution of the corresponding participant will have sufficient funds to pay the amount apportioned to each participant on the execution date; and
transmitting, via the one or more processors and/or transceivers associated with an OB service provider to the one or more processors and/or transceivers associated with the financial technology service provider, the preferred value associated with each participant of the group payment.

10. The computer-implemented method of claim 1, further comprising:
receiving, via one or more user interface inputs of the one or more devices associated with the organizer of the group payment, the terms of an automated payment agreement;
transmitting, via one or more processors and/or transceivers associated with the organizer of the group payment to the one or more processors and/or transceivers of the financial technology service provider, the terms of the automated payment agreement;
receiving, via the one or more processors and/or transceivers associated with the organizer of the group payment from the one or more processors and/or transceivers of the financial technology service provider, a notification comprising the proposed alternative date; and
transmitting, via the one or more processors and/or transceivers associated with the organizer of the group payment to the one or more processors and/or transceivers of the financial technology service provider, the acceptance of the proposed alternative date.

11. A computer-implemented method for mitigating an indication of insufficient funds associated with one or more participants of a group payment based upon open banking (OB) data, the computer-implemented method comprising:
receiving, via one or more processors and/or transceivers associated with an OB service provider from selected financial institutions associated with participants of the group payment, the OB data associated with each participant of the group payment;
receiving, via the one or more processors and/or transceivers associated with the OB service provider from one or more devices associated with a financial technology service provider, an execution date of the group payment;
determining, via the one or more processors associated with the OB service provider, a first preferred value associated with each participant of the group payment based upon the OB data, the first preferred value representing a likelihood that an account with the selected financial institution of the corresponding participant will have sufficient funds to pay an amount of the group payment apportioned to the corresponding participant on the execution date;
determining, via the one or more processors associated with the OB service provider, a proposed alternative date on which to execute payment of the amount of the group payment apportioned to one or more of the participants and having a second preferred value that is higher than the first preferred value; and
transmitting, via one or more processors and/or transceivers associated with the OB service provider to the one or more devices associated with the financial technology service provider, the proposed alternative date on which to execute payment of the amount of the group payment apportioned to the one or more of the participants.

12. The computer-implemented method of claim 11, further comprising:
determining, via the one or more processors associated with the OB service provider, that one or more participants of the group payment do not immediately have sufficient funds to pay the amount of the group payment apportioned to the corresponding participant;
transmitting, via one or more processors and/or transceivers associated with an OB service provider to one or more devices associated with the one or more participants of the group payment, a request for a secondary account for paying the amount of the group payment apportioned to the corresponding participant; and
receiving, via one or more processors and/or transceivers associated with an OB service provider, a selection of the secondary account.

13. The computer-implemented method of claim 11, further comprising:
transmitting, via one or more processors and/or transceivers associated with an OB service provider to the one or more devices associated with the financial technology service provider, a payment status of each participant of the group payment; and
transmitting, via one or more processors and/or transceivers associated with an OB service provider to the one or more devices associated with the financial technology service provider, the first preferred value associated with each participant of the group payment.

14. The computer-implemented method of claim 11, wherein receiving, via the one or more processors and/or transceivers associated with the OB service provider from one or more devices associated with a financial technology service provider, the execution date of the group payment comprises receiving, via the one or more processors and/or transceivers associated with the OB service provider from one or more devices associated with a financial technology service provider, an identifier of a smart contract stored on a blockchain.

15. A computer-implemented method for routing a group payment based upon open banking (OB) data, the computer-implemented method comprising:
receiving, via one or more processors and/or transceivers associated with a financial technology service provider from one or more devices associated with an organizer of the group payment, terms of a smart contract, the terms comprising an execution date of the group payment, an amount apportioned to each participant of the group payment, and contact information of each participant of the group payment;
generating, via the one or more processors and/or transceivers associated with the financial technology service provider, the smart contract having the terms;
storing, via the one or more processors and/or transceivers associated with the financial technology service provider, the smart contract on a digital ledger; and
transmitting, via the one or more processors and/or transceivers associated with the financial technology service provider, the terms of the smart contract to each participant device using the contact information of each participant of the group payment.

16. The computer-implemented method of claim 15, wherein the digital ledger is a centralized database in communication with the one or more processors and/or transceivers associated with the financial technology service provider.

17. The computer-implemented method of claim 15, wherein the digital ledger is a distributed ledger system.

18. The computer-implemented method of claim 17, wherein the distributed ledger system is a blockchain.

19. The computer-implemented method of claim 15, wherein the terms include an additional amount apportioned to each participant of the group payment.

20. The computer-implemented method of claim 19, wherein the terms include one or more predefined options for directing the additional amount, further comprising receiving, via the one or more processors and/or transceivers associated with the financial technology service provider from one or more devices associated with each participant, a selection of the one or more predefined options.
